(19) United States
(12) Patent Application Publication
(10) Pub. No.: US 2026/0079471 A1
(43) Pub. Date: Mar. 19, 2026

(54) System and Method for Reducing Latency of Process Recipe Execution in a Semiconductor Process System

(71) Applicant: Yang Pan, SINGAPORE (SG)

(72) Inventor: Yang Pan, SINGAPORE (SG)

(73) Assignee: Inspiring Atoms Pte Ltd, SINGAPORE (SG)

(21) Appl. No.: 18/885,725

(22) Filed: Sep. 15, 2024

(51) Int. Cl. G05B 19/4099

(52) U.S. Cl. CPC G05B 19/4099; G05B 2219/45031

(57) ABSTRACT

Disclosed herein is a control system for semiconductor manufacturing, focusing on reducing process recipe execution latency. The control system converts a process recipe into time series instructions and control signals for subsystem actuators, stored in subsystem local buffers for rapid executions. Latencies for various subsystems are managed by adjusting control signal execution timings. This approach enhances operational speed and repeatability, utilizing a mix of shared data bus and dedicated communication links for efficient data transfer.

### FIELD OF THE INVENTION

The present invention relates to semiconductor manufacturing equipment and process control systems. More specifically, it pertains to a system and method for managing and executing process recipes in semiconductor process equipment. This invention addresses the need for increased precision, speed, and repeatability in executing complex semiconductor manufacturing processes. It is relevant to process control, system communication, and latency management in semiconductor fabrication technology.

### BACKGROUND OF THE INVENTION

The semiconductor manufacturing industry is continuously advancing with increasing demands for higher efficiency and precision in production processes. As semiconductor devices become more complex and production cycles accelerate, there is a growing need for advanced control systems that can manage these intricate processes with minimal latency and maximum repeatability.

Historically, semiconductor process equipment has relied on control systems that execute process recipes in a sequential manner. This approach has often led to inefficiencies and delays due to system and subsystem latencies. Such conventional systems have struggled to meet the escalating complexity and precision required by modern semiconductor fabrication techniques.

Additionally, communication infrastructure within these systems has typically depended on a shared data bus, which presents limitations in terms of flexibility and speed. As semiconductor devices continue to scale down and new materials and processes are introduced, the need for precise control becomes even more critical, exacerbating the limitations of existing systems.

There is a need for a system that efficiently converts process recipes into time series instructions for each subsystem, effectively manages latency, and utilizes an optimized communication framework. Such a system would improve the speed and efficiency of semiconductor manufacturing while enhancing the accuracy and consistency of the final products—both key factors in the competitive semiconductor industry.

The present invention addresses these challenges by providing a novel method and system for process control in semiconductor manufacturing. It focuses on reducing latency, increasing operational speed, and ensuring repeatability in process execution, thereby meeting the industry's evolving demands.

### SUMMARY

In some embodiments, the method involves converting a process recipe into time series instructions for each subsystem. This enables precise control over various processes involved in semiconductor fabrication, such as deposition and etching.

In certain implementations, managing latency is a key aspect. Semiconductor processes demand high accuracy and repeatability, and even small delays can affect product quality and yield. By adjusting the timing of control signals to account for the latencies of each subsystem, the system minimizes execution delays, which helps accelerate the process and improve consistency.

In some embodiments, the use of local subsystem buffers for storing time series control signals is a critical feature. These buffers allow for faster access to instructions, leading to quicker response times and enhanced throughput in the manufacturing process.

In other implementations, the method includes a flexible communication framework, which uses shared data buses and dedicated links. This framework optimizes communication paths based on the needs of different subsystems, ensuring efficient data transfer and instruction execution.

The system and method also address methods for synchronizing subsystem clocks with the system clock. Timing precision is essential in semiconductor processes, and synchronization ensures consistent product quality and reliability.

Overall, this disclosure introduces a method for managing and executing process recipes in semiconductor equipment, with a focus on reducing latency and incorporating features such as local buffers and a flexible communication framework. These improvements enhance the speed, accuracy, and repeatability of semiconductor manufacturing, meeting the demands of the evolving industry.

### BRIEF DESCRIPTIONS OF THE DRAWINGS

For enhanced clarity, the following description references the accompanying drawings:

FIG. 1 illustrates an exemplary process system.

FIG. 2 shows a communication link between a system controller and subsystems via a shared data bus in a process system.

FIG. 3A presents a schematic diagram of an exemplary control system for a process system.

FIG. 3B illustrates an example of adjusting starting timings of different subsystems according to their latencies.

FIG. 4 illustrates an embodiment of the controller system utilizing a shared communication link between the system controller and subsystem controllers.

FIG. 5 illustrates another embodiment of the controller system with dedicated communication links between the system controller and subsystem controllers.

FIG. 6 illustrates yet another embodiment of the controller system with a combination of shared and dedicated communication links between the system controller and subsystem controllers.

FIG. 7 depicts a flowchart outlining a method for executing a process recipe with reduced latency due to the process system and its subsystems.

### DETAILED DESCRIPTIONS

This section provides detailed embodiments of the present invention. Although specific examples are provided for clarity, modifications and variations consistent with the claims are within the scope of the invention. Conventional methods and components are mentioned to highlight the distinct features of the invention.

Terms used in this disclosure are defined as follows:

Anisotropic ALE (or simply as ALE): Refers to an etching process used in semiconductor manufacturing that removes material layer by layer at the atomic scale, offering precise control over etch depth and profile. ALE operates in cycles, typically involving a surface modification step, where the surface is chemically altered, followed by a sputtering step, where physical ion bombardment removes the modified layer. This method provides high precision and selectivity.

Plasma Enhanced ALD (or simply ALD): Refers to a technique that employs plasma to enhance chemical reactions on the substrate surface during film deposition. The ALD process typically involves a dosing step, where the substrate is exposed to one or more precursors, and a plasma activation step, where a reactive gas generates species like radicals. These radicals accelerate reaction kinetics, allowing for lower deposition temperatures and improved film properties, including higher density and better conformality. ALD is particularly advantageous for depositing high-quality thin films on temperature-sensitive substrates and in applications requiring precise control over film characteristics.

Bias Unit: In some embodiments, this unit generates a controlled voltage that accelerates ions toward the wafer held by an electrostatic chuck (ESC). The bias creates an electric field that enhances ion bombardment, ensuring precise control of ion energy and directionality during etching.

Chamber: An enclosed environment within process equipment where semiconductor manufacturing processes, such as etching or deposition, occur.

Chuck: A component designed to hold and secure the wafer in place during semiconductor manufacturing processes.

EtherCAT (Ethernet for Control Automation Technology): Refers to a communication protocol used in industrial automation that allows multiple devices, such as controllers and sensors, to exchange data over a single Ethernet network. EtherCAT operates at speeds up to 100 Mbps, ensuring precise control and coordination between devices

ESC (Electrostatic Chuck): A type of chuck that uses electrostatic forces to hold the wafer in place during semiconductor processing, providing uniform clamping and stability.

Gas Distribution Unit: In some implementations, this unit introduces and distributes process gases uniformly across the substrate. For example, injectors can be positioned centrally or at specific angles, while a showerhead configuration disperses gas evenly. Additionally, side injection mechanisms can promote lateral gas flow for more even distribution.

Gas Source: The point of origin or supply of process gases used in a vacuum process chamber. In certain embodiments, a gas box regulates and controls the flow of gases, delivering them under controlled pressure and conditions.

Latency: In the context of a semiconductor process system and its subsystems, latency refers to the delay between the issuance of a control signal by the system controller and the execution of that signal by a subsystem, such as an RF power generator, mass flow controller, or valve. This delay can result from various factors, including communication transmission time, processing time within subsystems, and mechanical response time. Reducing latency is critical in semiconductor manufacturing to ensure precise timing, synchronization, and accuracy of process steps, thereby improving overall process performance and product quality.

Plasma-Enhanced Chemical Vapor Deposition (or PECVD): Refers to a semiconductor manufacturing process used to deposit thin films on a substrate. In PECVD, plasma energizes a precursor gas, enhancing chemical reactions at the substrate surface, allowing deposition at lower temperatures. It is commonly used for depositing dielectric layers, such as silicon dioxide or silicon nitride, with precise control over film thickness and uniformity.

PID Control: A control loop mechanism involving proportional-integral-derivative (PID) actions to regulate variables such as temperature, pressure, and gas flow. In some embodiments, PID control ensures stable and accurate process conditions during semiconductor manufacturing.

Plasma Process Chamber: A vacuum chamber specifically designed for processes involving plasma, such as etching or deposition, where plasma provides the necessary energy for activating chemical reactions or material removal.

Plasma Source: In some implementations, the plasma source generates plasma for processes like etching, deposition, or surface modification. Examples include inductively coupled plasma (ICP), transformer coupled plasma (TCP), and capacitively coupled plasma (CCP).

Process System: Refers to the integrated equipment used in semiconductor manufacturing to carry out various processes, such as deposition and etching.

Reactive Ion Etching (RIE): A plasma-based etching technique where both physical ion bombardment and chemical reactions synergistically remove material from the substrate. RIE provides highly selective and anisotropic etching, essential for intricate microfabrication.

Resonator: A device or circuit component that resonates at a specific radio frequency (RF), used in applications like RF impedance matching.

RF Power Generator: A device that generates RF power used to energize plasma in processes like etching or deposition.

Substrate: The base material, typically a silicon wafer, upon which semiconductor devices are fabricated.

System Controller: The central unit managing and controlling process system operations, ensuring coordinated and efficient functioning of semiconductor manufacturing processes.

Transmission Line (in RF): A conductor designed to carry RF signals with minimal loss and distortion. Transmission lines ensure efficient power transfer in semiconductor manufacturing processes, such as etching or deposition.

Vacuum Chamber: An enclosed space where air and other gases are removed to create a low-pressure environment, essential for precision semiconductor manufacturing processes.

von Neumann machine: Refers to a computer architecture in which a central processing unit (CPU) runs instructions sequentially from a stored program. The key feature of this design is that both data and instructions are stored in the same memory, and the CPU fetches them one at a timing for execution. This architecture forms the basis for most computers and is characterized by a fetch-decode-execute cycle that processes each instruction step by step.

Window: In a vacuum chamber, this window separates the plasma generation region from external components. It is typically non-conductive, allowing electromagnetic waves, such as RF or microwave energy, to pass through.

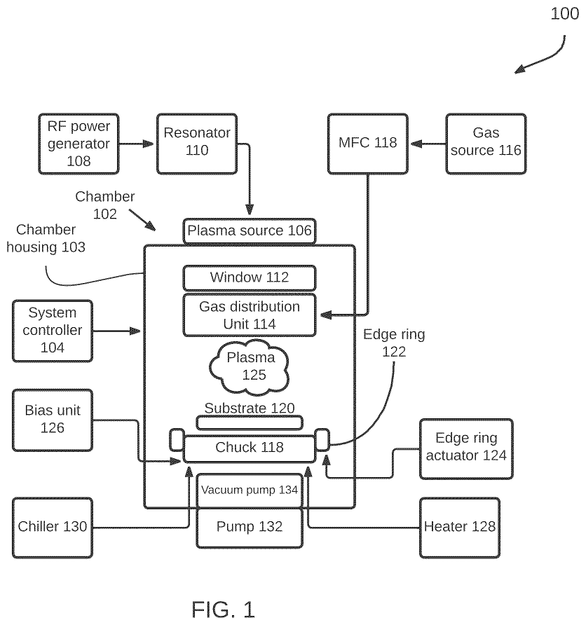

FIG. 1 depicts an exemplary process system, designated as 100. Although the process system 100 is designed for an etching process like an atomic layer etching (ALE), the design concept is general for a plasma based process for illustrating the present inventive concept. The system includes a chamber 102, controlled by a system controller 104. Surrounding the chamber is a housing 103 that creates a vacuum environment suitable for plasma processing. Chamber housing 103, made from materials like aluminum or quartz, may feature an anodized or yttrium oxide coating on its interior surface to enhance resistance to plasma.

Above the chamber housing 103 is a plasma source 106, positioned beneath a window 112 that hermetically seals the chamber 102. The window, made of quartz or ceramics, may have a plasma-resistant coating such as yttrium oxide.

Plasma source 106 can take various forms, such as multiple-turn coils, and may be cylindrical or conical in shape. It is connected to a radio frequency (RF) power generator 108 through a resonator 110, which matches the output impedance of the RF power generator to the plasma load in the chamber. The RF generator 108 operates at frequencies ranging from 100 kHz to 60 MHz. Resonator 110 is crucial in compensating for transmission line effects during operation.

A gas distribution unit 114, connected to a gas source 116 via a mass flow controller (MFC) 118, supplies process gases to the chamber. MFC 118 regulates the flow rate of gases, with multiple MFCs used for controlling different gases. Some configurations may use a manifold (not shown) to mix gases before their introduction into the gas distribution unit 114.

The gas distribution unit 114 may function as either an injector or a showerhead. In some configurations, the window 112 is integrated with the gas distribution unit 114, serving both as a showerhead and as a chamber seal.

Additionally, the chamber 102 includes a pump 132 and a vacuum valve 134. The pump 132, such as a turbo molecular pump (TMP), removes unused gases and byproducts from the chamber. The system controller 104 manages the MFC 118, pump 132, and valve 134 to maintain stable chamber pressure, which can be monitored by a manometer (not shown).

Inside the chamber, a chuck 118 supports a substrate 120 during processing. The chuck may take various forms, such as an electrostatic chuck (ESC) or a vacuum chuck. In some embodiments, the chuck 118 is surrounded by an edge ring 122. The edge ring 122 may be made from materials such as ceramic, silicon carbide, or quartz. In some implementations, the edge ring 122 is movable by an edge ring actuator 124. In some other implementations, the edge ring 122 is powered.

The temperature of the chuck's surface is adjustable using a heater 128 and a chiller 130. In some implementations, the chuck's surface is divided into several zones, each with independently controlled temperatures.

A bias unit 126 is connected to the chuck, providing a bias to both the chuck and the substrate. The bias unit is essential for controlling ion energy during processing and can operate as an RF power generator at frequencies ranging from 100 kHz to 60 MHz. A resonator is used to match the impedance between the RF generator and the chamber load through the chuck. In some configurations, the bias unit 126 can be a tailored waveform generator to optimize ion energy distribution.

The process system 100 supports a variety of processes, including atomic layer etching (ALE), reactive ion etching (RIE), plasma-enhanced chemical vapor deposition (PECVD), atomic layer deposition (ALD), thermal etching, and thermal deposition. In thermal process systems, RF-related subsystems may be omitted.

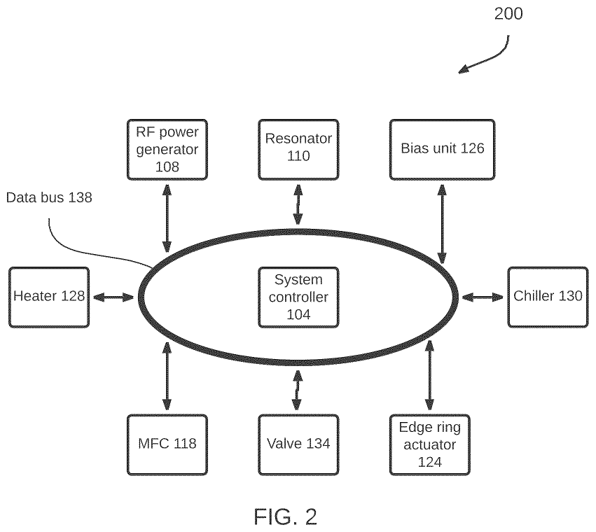

In all embodiments, the system controller 104 receives a process recipe and converts it into sequential time series instructions for the subsystems. A typical process recipe comprises multiple steps, executed sequentially by the system controller through a control system, as schematically illustrated in FIG. 2. The controller transmits step-specific instructions for the actuators in each subsystem via a data bus 138. Each subsystem controller receives and executes the specific instructions for its respective step.

The process system 100 operates similarly to a sequential program machine, such as a von Neumann machine, where each step of the recipe is executed sequentially. As shown in FIG. 2, the subsystems include, but are not limited to, the RF power generator 108, resonator 110, bias unit 126, heater 128, chiller 130, MFC 118, valve 134, and edge ring 122. Some subsystems may have dedicated controllers, while others may share a controller. For instance, the RF power generator 108 and resonator 110 may share an RF controller. In some implementations, the system uses a real-time communication protocol, such as EtherCAT, operating at 100 Mbps to transmit instructions. Minimizing transmission latency is crucial to speeding up process execution and enhancing repeatability.

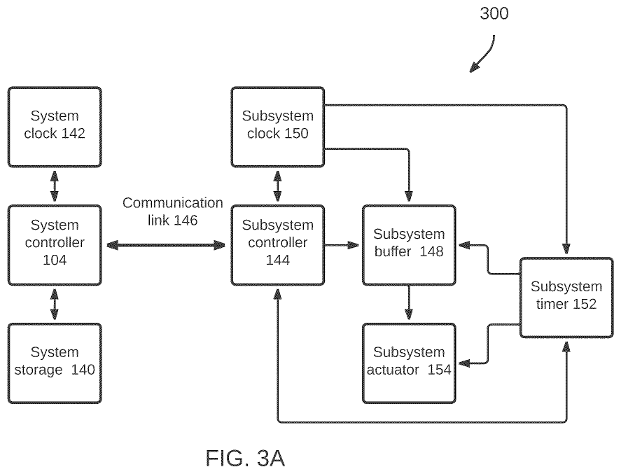

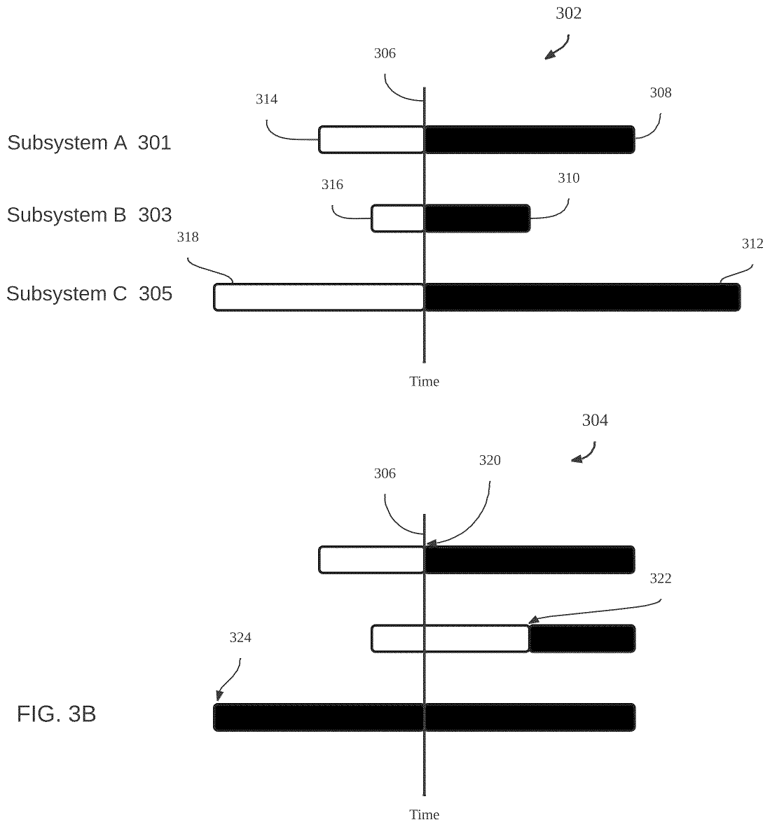

FIG. 3A illustrates a schematic diagram of an exemplary control system 300 for the process system 100. While only one subsystem is shown, the system typically includes multiple subsystems. The control system comprises the system controller 104, system storage 140, and system clock 142. The system controller 104 connects to a subsystem controller 144 via a communication link 146. Subsystem controller 144 connects to a subsystem buffer 148, which may consist of static random access memory (SRAM). The system controller 104 converts the process recipe into time series instructions for the subsystems, encompassing all recipe steps.

Subsystem controller 144 transforms the instructions into control signals, storing them in the subsystem buffer 148. A subsystem clock 150, synchronized with the system clock 142, enables the precise delivery of control signals to the subsystem actuator 154.

Subsystem latency—the time required to deliver and execute control signals—is minimized by a subsystem timer 152, which can be implemented via software, firmware, hardware, or a combination. The timer adjusts the timing of control signal delivery to reduce latency.

For example, in the case of an MFC, the MFC controller receives a series of flow rate instructions based on the process recipe and converts them into control currents for a solenoid coil. The solenoid adjusts the flow rate by moving a plunger. The control current is stored in fast SRAM, and the MFC controller retrieves it at a predetermined time, delivering it to the solenoid coil. The plunger movement typically takes several milliseconds, and the subsystem timer compensates for this delay by adjusting the timing of the current delivery.

Latencies associated with subsystem operations, such as solenoid activation, are either calculated or measured. The subsystem timer adjusts the delivery of control signals to compensate for these latencies, thereby improving the overall timing and efficiency of the process system.

FIG. 3B illustrates an example for managing subsystem latencies. A conventional method is represented by 302, and an improved method by 304. The starting timing of a step, defined by a process recipe, is indicated by vertical line 306 in FIG. 3B. Subsystem A (301) has an associated latency, depicted as 308, and an available or idle time before the step begins, labeled as 314. At the end of the latency period, the subsystem becomes effective. For example, in the case of an RF subsystem, RF power is delivered to the ICP coil at the end of its latency, which encompasses the time required to receive an instruction from the subsystem controller, interpret the instruction, convert DC power to RF power, match the impedance, and transfer the power from the generator to the coil.

Similarly, subsystems B (303) and C (305) have latencies represented by 310 and 312, and available times shown as 316 and 318, respectively. In the conventional method (302), if all three subsystems begin exactly at the step starting timing 306, they will become effective at different times, with subsystem C (305) being the limiting factor due to its longer latency.

The improved method (304) initiates subsystems A, B, and C at distinct starting timings, labeled as 320, 322, and 324, respectively. Specifically, the available or idle time 318 for subsystem C is leveraged to accommodate its longer latency. This adjustment allows the subsystems to overcome their respective latencies at approximately the same timing.

It should be noted that this illustration is merely an example. In certain applications, a subsystem may require a different effective timing. For instance, a process chamber must reach a steady-state pressure before plasma ignition. This offset in starting times can be designed based on the same methodology.

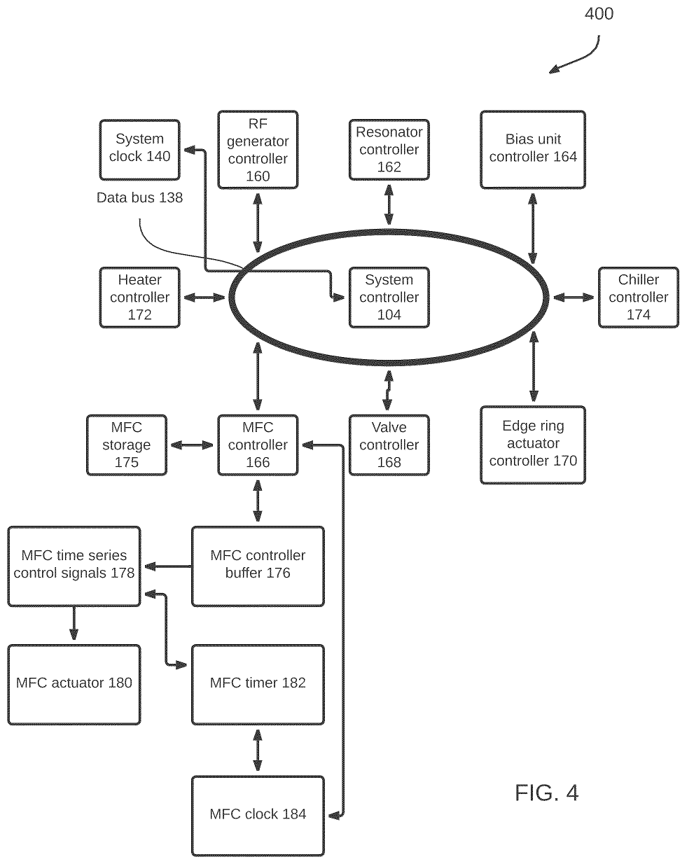

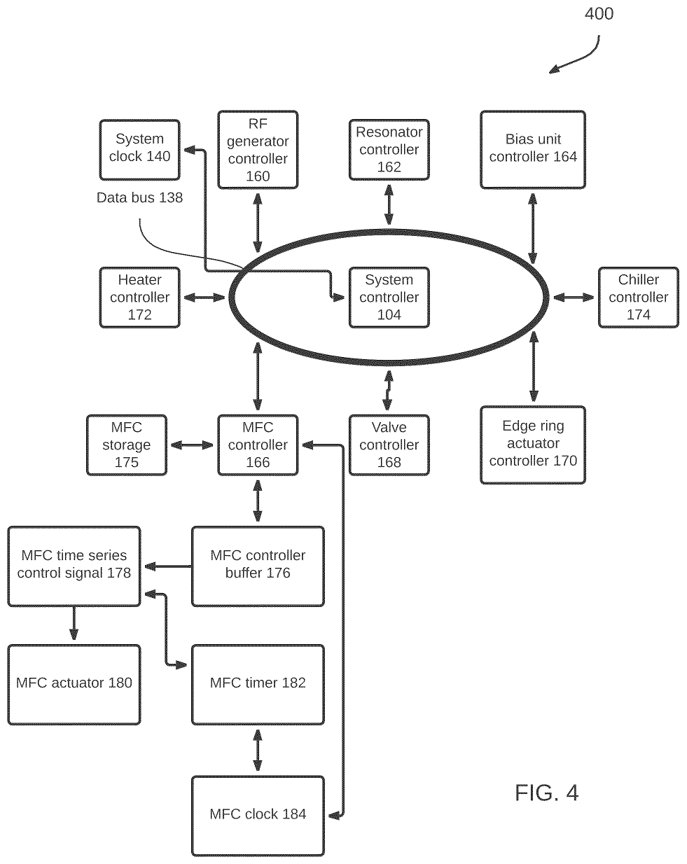

FIG. 4 illustrates an embodiment of the controller system 400, featuring a shared data bus 138 that enables communication between the system controller 104 and various subsystem controllers. Upon receiving a process recipe, the system controller 104 converts the recipe into time series instructions for the subsystems or components listed in FIG. 4. These instructions are then transmitted to each subsystem controller via the shared data bus 138, as shown. In one implementation, the shared data bus incorporates the EtherCAT protocol as part of the communication link. The subsystem controllers include, but are not limited to, RF generator controller 160, resonator 162, bias unit controller 164, MFC controller 166, valve controller 168, edge ring actuator controller 170, heater controller 172, and chiller controller 174. It is important to note that the subsystems and components listed are exemplary, and the process system 100 may feature a varying number of elements, all falling within the scope of this inventive concept.

Elaborating on this inventive concept, as demonstrated in FIG. 3A, the MFC is used as an example to illustrate how a subsystem/component operates beyond its controller, although similar control mechanisms apply to other subsystems. The MFC controller 166 connects to an MFC controller buffer 176, which stores time series control signals 178 for the MFC. These control signals 178 are applied to the MFC actuator 180 at predetermined intervals. An MFC timer 182 shifts the timing of these signals based on the calculated or measured latency when executing a control signal. Additionally, the MFC is equipped with an MFC clock 184, synchronized with the system clock 140.

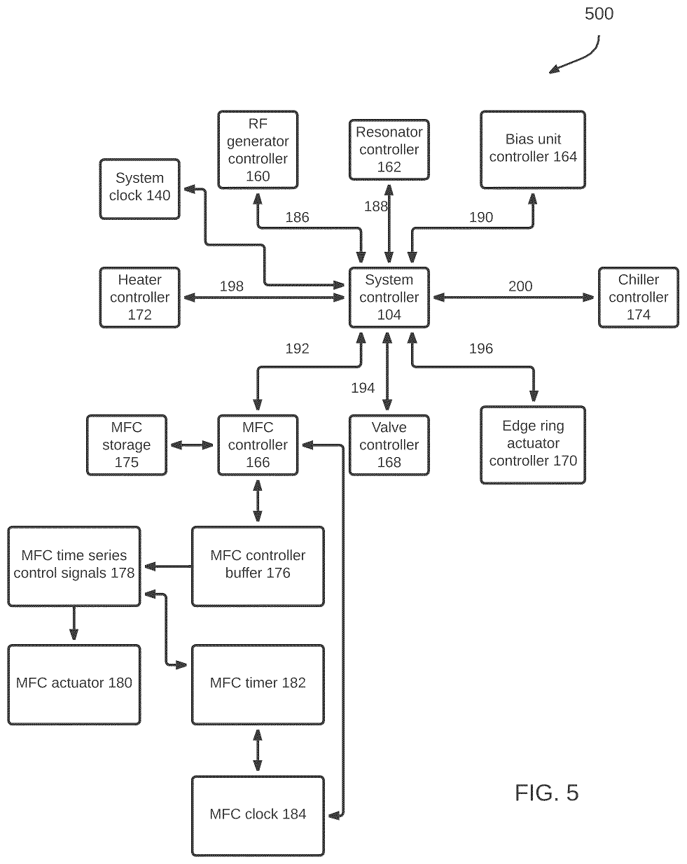

FIG. 5 introduces another embodiment of the controller system, utilizing dedicated communication links between the system controller and subsystem controllers. As depicted, these dedicated communication links include, but are not limited to, a link 186 between the system controller 104 and RF generator controller 160, a link 188 between the system controller 104 and resonator controller 162, a link 190 between the system controller 104 and bias unit controller 164, a link 192 between the system controller 104 and MFC controller 166, a link 194 between the system controller 104 and valve controller 168, a link 196 between the system controller 104 and edge ring actuator controller 170, a link 198 between the system controller 104 and heater controller 172, and a link 200 between the system controller 104 and chiller controller 174. These dedicated links expedite communication between the system controller and subsystems/components. Depending on the implementation, these communication links may consist of electrical cables, optical fibers, wireless communication channels, or a combination of these methods.

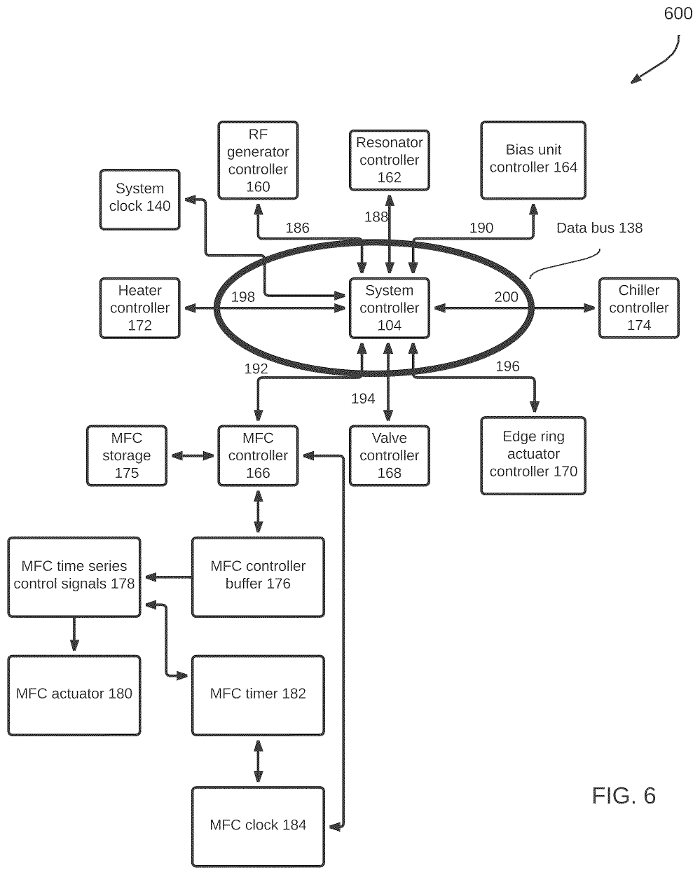

FIG. 6 presents yet another embodiment of the controller system, featuring a combination of a shared communication link (data bus 138) and dedicated links (186, 188, 190, 192, 194, 196, 198, and 200) for communication between the system controller 104 and the subsystem controllers.

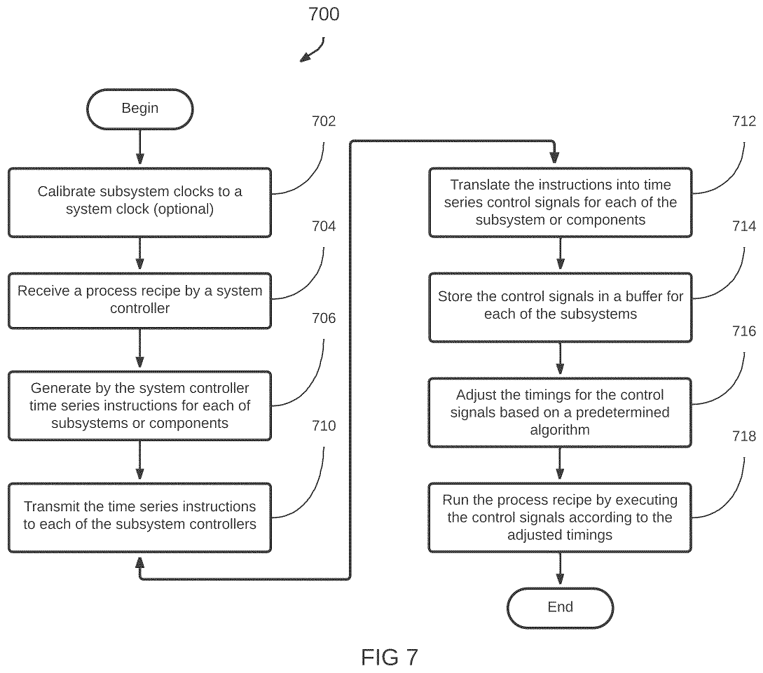

FIG. 7 illustrates a flowchart outlining a method for executing a process recipe with minimized latency within the process system and its subsystems. The process, referred to as process 700, begins at step 702, where all subsystem clocks are synchronized with the system clock. The frequency of this calibration may vary; in one instance, clocks are calibrated prior to executing the process recipe, while in another, calibration occurs during system installation. Calibration may also occur based on user-defined frequencies.

At step 704, the system controller 104 receives the process recipe, which may be provided by a user, generated by the system controller, or created by any computer. Subsequently, at step 706, the system controller 104 generates time series instructions for each subsystem or component, ideally covering the entire process recipe from start to finish.

In step 710, these time series instructions are transmitted to the subsystems/components via various communication links, which can include the shared data bus, dedicated links, or a combination of both. At step 712, the subsystem controllers convert the received time series instructions into corresponding control signals.

Step 714 involves storing these time series control signals in the buffers of the subsystems. Then, in step 716, the timing of each control signal is adjusted according to a predefined algorithm. This algorithm shifts the starting timing based on the calculated or measured latency of the subsystems/components.

Finally, at step 718, the process recipe is executed by applying the adjusted control signals to the actuators of the subsystems/components, thus completing the process with minimized latency.

1. A process system for manufacturing a substrate, comprising:
a chamber maintaining an interior space for a vacuum environment;
a plurality of subsystems, wherein each subsystem includes a subsystem controller, a storage buffer, and an actuator; and
a system controller configured to convert a process recipe into time series instructions for each of the subsystems, wherein the time series instructions are transmitted to the subsystems and stored in the storage buffer, and wherein the instructions are further converted into time series control signals by the subsystem controller, with the actuator being activated according to the time series control signals for each subsystem.

2. The process system of claim 1, wherein the process system further includes a system clock and a subsystem clock for each of the subsystems, wherein the clocks are calibrated before the process recipe is executed.

3. The process system of claim 2, wherein the subsystems further include a timer, wherein the timer is employed to adjust the time series control signals to minimize effects of latencies caused by the subsystems.

4. The process system of claim 1, wherein the system controller transmits the time series instructions to each of the subsystems before the process recipe is executed.

5. The process system of claim 1, wherein each of the subsystem controllers is coupled to the system controller through a dedicated communication link.

6. The process system of claim 5, wherein the communication link includes either an electrical cable or an optical fiber.

7. The process system of claim 1, wherein each of the subsystem controllers is coupled to the system controller through a shared data bus.

8. The process system of claim 1, wherein each of the subsystem controllers is coupled to the system controller through a mix of dedicated communication links and a shared data bus.

9. The process system of claim 1, wherein the subsystems include an RF power generator, a resonator, a bias unit for a chuck supporting the substrate, an MFC, a vacuum valve, a heater, and a chiller.

10. The process system of claim 1, wherein the process systems further include: an ALE process system, an RIE process system, a PECVD process system, an ALD process system, a thermal etching process system, and a thermal deposition process system.

11. The process system of claim 1, wherein the subsystem buffer includes SRAM.

12. A method of executing a process recipe utilizing a process system, comprising:
receiving a process recipe by a system controller;
generating time series instructions for each of the subsystems by the system controller;
transmitting the time series instructions to each of the subsystem controllers;
translating the instructions into time series control signals by the subsystem controllers;
storing the time series control signals in each subsystem buffer;
adjusting timings for the control signals based on a predetermined algorithm; and
executing the process recipe by applying the control signals to actuators of the subsystems according to adjusted timings.

13. The method of claim 12, wherein the method further includes a step of calibrating the clocks of the subsystem controllers to a clock of the system controller.

14. The method of claim 12, wherein the step of adjusting the timings further includes calculating a latency from executing of a specific control signal to functionalize the actuator.

15. The method of claim 14, wherein the predetermined algorithm further includes adjusting the timings based on the calculated or measured latencies.

16. The method of claim 12, wherein the step of transmitting the time series instructions to the subsystems further includes transmitting the instructions to each of the subsystems in parallel through dedicated communication links.

17. The method of claim 12, wherein the step of transmitting the time series instructions to the subsystems further includes transmitting the instructions sequentially based on a shared data bus.

18. The method of claim 12, wherein the step of transmitting the time series instructions to the subsystems further includes transmitting the instructions through a mix of dedicated communication links and shared data bus.

19. The method of claim 12, wherein the subsystems include an RF power generator, a resonator, a bias unit for a chuck supporting the substrate, an MFC, a vacuum valve, a heater, and a chiller.

20. The method of claim 12, wherein the process systems further include: an ALE process system, an RIE process system, a PECVD process system, an ALD process system, a thermal etching process system, and a thermal deposition process system.
